(19) United States
(12) Patent Application Publication
(10) Pub. No.: US 2014/0350844 A1
(43) Pub. Date: Nov. 27, 2014

(54) METHOD FOR SEARCHING DATA AND METHOD FOR PLANNING ITINERARY

(71) Applicants: Kai-Yi Chen, Taipei City (TW); Pin-Yu Chou, Taipei City (TW); Hsiu-Hang Lin, Taipei City (TW); Ching-Wen Sun, Taipei City (TW); Yu-Tzu Hsu, Taipei City (TW)

(72) Inventors: Kai-Yi Chen, Taipei City (TW); Pin-Yu Chou, Taipei City (TW); Hsiu-Hang Lin, Taipei City (TW); Ching-Wen Sun, Taipei City (TW); Yu-Tzu Hsu, Taipei City (TW)

(73) Assignee: COMPAL ELECTRONICS, INC., Taipei City (TW)

(21) Appl. No.: 14/284,400

(22) Filed: May 22, 2014

Related U.S. Application Data
(60) Provisional application No. 61/827,663, filed on May 26, 2013.

(51) Int. Cl. G01C 21/36

(52) U.S. Cl. CPC G01C 21/3679; G01C 21/3682
USPC 701/426

(57) ABSTRACT

A method for searching data and a method for planning itinerary are provided. At least one contact is selected from a contact list so as to set a point of interest (POI) list associated with the at least one contact as a specific data source. A POI category is decided. A preset search range is obtained based on a reference location so as to search the specific data source for obtaining a search result conformed to the POI category and the preset search range, and the search result is displayed.

### CROSS-REFERENCE TO RELATED APPLICATION

This application claims the priority benefits of U.S. provisional application Ser. No. 61/827,663, filed on May 26, 2013. The entirety of the above-mentioned patent applications is hereby incorporated by reference herein and made a part of this specification.

### BACKGROUND OF THE INVENTION

1. Field of the Invention

The invention relates to a method for searching data, and more particularly, relates to a method for searching data and a method for planning itinerary, which are based on contact preference.

2. Description of Related Art

With popularity of services provided in broadband network, more and more people are willing to upload digital data to the Internet for their own keeping or sharing with others. Behaviors and environments for sharing the digital data online have also grown mature these days. For example, in current era of smart phones being popularized, people may easily upload and share pictures taken by a smart phone, or performing a positioning action through the smart phone once arrived at a destination point and followed by sharing a positioning data to the others. Accordingly, data being share through the Internet is getting quite huge these days. Therefore, it also becomes more important to effectively search for a desired data from the huge amounts of data.

### SUMMARY OF THE INVENTION

The invention is directed to a method for searching data and a method for planning itinerary, capable of searching for point of interest (POI) data of one or more contact.

The method for searching data of the invention is adapted for an electronic apparatus. First, at least one contact is selected from a contact list so as to set a POI list associated with the selected contact as a specific data source, wherein the POI list includes one or more POI data. Thereafter, a POI category is decided, and a preset search range is obtained based on a reference location. The specific data source is searched for obtaining a search result conformed to the POI category and the preset search range, and the search result is displayed.

In an embodiment of the invention, the method for searching data further includes: displaying a selecting contact interface, so as to list the contact list in the selecting contact interface; and receiving an operation command of a user which selects the contact from the contact list through the selecting contact interface, so as to select the contact.

In an embodiment of the invention, the method for searching data further includes: displaying a selecting category interface, so as to list a category list in the selecting category interface; and receiving an operation command of a user which selects the POI category from the category list through the selecting category interface, so as to decide the POI category.

In an embodiment of the invention, the method for searching data further includes: displaying a selecting location interface for displaying the search result; and receiving an operation command of a user which selects one of the POI data from the search result through the selecting location interface, so as to set the selected POI data as a target location. Thereafter, the selected contact, the selected POI category and the selected target location are stored.

In an embodiment of the invention, the step of searching the specific data source for obtaining the search result conformed to the POI category and the preset search range includes: searching the specific data source for all POI data conformed to the POI category; and among the POI data conformed to the POI category, setting the POI data that fell within the preset search range to the search result.

In an embodiment of the invention, before the step of obtaining the preset search range based on the reference location, the method further includes detecting a current location of the electronic apparatus, and using the current location as the reference location.

In an embodiment of the invention, the method for searching data further includes: receiving a filter condition, so as to obtain the POI data conformed to the filter condition from the search result, wherein the filter condition includes the POI data associated with a user of the electronic apparatus.

The method for planning itinerary of the invention is adapted to an electronic apparatus. First, at least one contact is selected from a contact list so as to set a POI list associated with the selected contact to a specific data source, wherein the POI list includes one or more POI data. Thereafter, a POI category is decided, and a preset search range is obtained based on a reference location. The specific data source is searched for displaying the POI data conformed to the POI category and fell within the preset search range. Thereafter, one of the displayed POI data is selected as a target location. Lastly, the selected contact, the selected POI category and the selected target location are stored.

In an embodiment of the invention, the method for planning itinerary further includes: providing a user interface for the user to establish an itinerary plan. The user interface includes a contact block, a category block and a location block, the contact block being used to select the contact, the category block being used to decide the POI category, and the location block being used to decide the target location.

In an embodiment of the invention, the method for planning itinerary further includes: When the contact block is selected, displaying a selecting contact interface to list the contact list, and receiving a first operation command of the user through the selecting contact interface, so as to select the contact from the contact list. When the category block is selected, displaying a selecting category interface to list a category list, and receiving a second operation command of the user through the selecting category interface, so as to decide the POI category. When the location block is selected, displaying a selecting location interface to display the POI data conformed to the POI category and fell within the preset search range, and receiving a third operation command of the user through the selecting location interface, so as to select one of the displayed POI data as the target location.

Based on above, the POI data of one or more contacts are selected as the specific data source for searching desired data in the specific data source. Accordingly, the user is able to search the POI data of the contacts having similar interests, so as to improve accuracy in searching for the POI data of the user himself/herself.

To make the above features and advantages of the disclosure more comprehensible, several embodiments accompanied with drawings are described in detail as follows.

### BRIEF DESCRIPTION OF THE DRAWINGS

FIG. 1 is a block diagram of an electronic apparatus according to an embodiment of the invention.

FIG. 2 is a flowchart illustrating a method for searching data according to an embodiment of the invention.

FIG. 3A to FIG. 3J are schematic diagrams illustrating flows for planning itinerary according to an embodiment of the invention.

### DESCRIPTION OF THE EMBODIMENTS

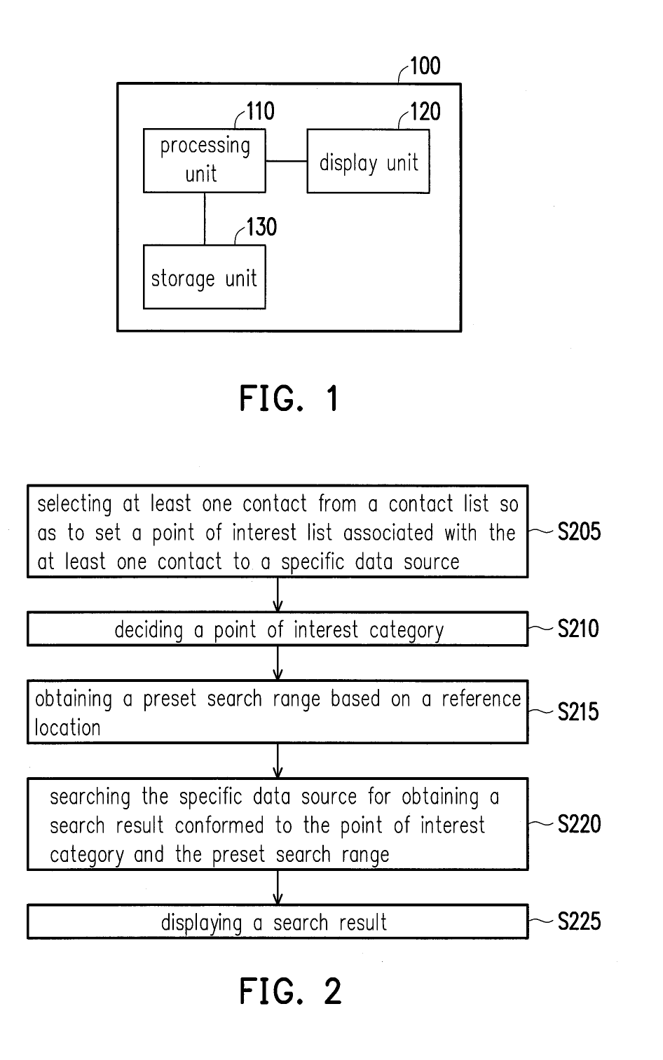

FIG. 1 is a block diagram of an electronic apparatus according to an embodiment of the invention. Referring to FIG. 1, for example, an electronic apparatus 100 may be a device with computing capabilities, such as a desktop PC, a notebook PC, a tablet PC, a smart phone and the like. The electronic apparatus 100 at least includes a processing unit 110, a display unit 120 and a storage unit 130. The processing unit 110 is coupled to the display unit 120 and the storage unit 130. The processing unit 110 is, for example, a central processing unit (CPU), a programmable microprocessor, or an embedded control chip and the like.

The display unit 120 is, for example, a liquid-crystal display (LCD), a plasma display, a vacuum fluorescent display, a light-emitting diode (LED) display, a field emission display (FED) and/or other appropriate displays; the display device type is not limited in the invention. Or, the display unit 120 may also be a display having a touch module.

The storage unit 130 is, for example, a fixed or a movable device in any possible forms including a random access memory (RAM), a read-only memory (ROM), a flash memory, a hard drive or other similar devices, or a combination of the above-mentioned devices. Herein, a computer program product is stored in the storage unit 130. Basically, the computer program product is assembled by a plurality of code snippets (i.e. an organization chart establishment code snippet, a form approval code snippet, a settings code snippet, and a deployment code snippet). Moreover, after the code snippets are executed after being loaded into the electronic apparatus 100, a method for searching data and a method for planning itinerary as described below may be executed by the processing unit 110.

FIG. 2 is a flowchart illustrating a method for searching data according to an embodiment of the invention. In the present embodiment, when a user starts the computer program product for searching data in the electronic apparatus 100, the processing unit 110 may start executing the following flows based on the operation command of the user.

Referring to FIG. 2, in step S205, at least one contact is selected from a contact list so as to set a point of interest (POI) list associated with the at least one contact as a specific data source. The POI list includes one or more POI data. For example, a selecting contact interface is started in the display unit 120 to display the contact list, so that the user may select one or more contacts from the contact list. After a corresponding operation command is received by the processing unit 110 through a mouse, a keyboard, a touch module and so on, the contact may be correspondingly selected based on such operation command, and all of the POI data in the POI list associated with the selected contact may be set to the specific data source to be used as a basis of database in subsequent data searching.

More specifically, people may use a registered account to log in an application or a social network for location positioning, so as to establish the POI data associated to such account in the application or a server of the social network. The POI data includes at least one of a coordinate, an address, a landmark name, a building name of a positioning point, or the POI data may also be an article or a note. Herein, once the user of the electronic apparatus 100 starts the computer program product for searching data, after the contact is selected, the processing unit 110 further connects to the related server through a communication unit to obtain the related POI list.

Next, in step S210, a POI category is decided. In the present embodiment, the computer program product provides, for examples, a plurality of primary categories for the user to select from, and each of the primary categories further includes a plurality of secondary categories, but the invention is not limited thereto. The secondary category is selected after selecting the primary category. Or, the user may also establish the POI category of his/her own. For example, a selecting category interface may be started in the display unit 120 to list a category list for the user to select from, so that the processing unit 110 may select the POI category based on the corresponding operation command received through the mouse, the keyboard, the touch module and so on. Further, a corresponding set of keywords may be set to each POI category as to facilitate in searching. After the POI category is decided, the corresponding set of keywords may be utilized for searching. However, above description is merely an implementation, and the invention is not limited thereto. For example, a corresponding POI category may also be set for a category tag included in each of servers providing location positioning function.

Thereafter, in step S215, a preset search range is obtained based on a reference location. For example, the electronic apparatus 100 may further include a positioning module, so as to detect a current location of the electronic apparatus 100 through the positioning module, and set the current location to the reference location. Thereafter, the preset search range may be set with the current location as a center point. Or, the user may also manually enter the reference location instead of using the current location as the reference location.

Next, in step S220, the specific data source is searched for obtaining a search result conformed to the POI category and the preset search range. For example, the POI data conformed to the POI category may be searched in the specific data source, and the POI data fell within the preset search range in the POI data conformed to the POI category may be set to the search result. Further, in step S225, the search result is displayed in the display unit 120. Accordingly, the user may find data of his/her own interest in the POI data of friends. In addition, the processing unit 110 may further receive a filter condition, so as to obtain the POI data conformed to the filter condition from the search result. Aforesaid filter condition includes the POI data associated to the user of the electronic apparatus 100. Accordingly, through aforesaid method, places visited by both the user and the friends may be found, or places already visited by the user may be filtered out from the places visited by the friends.

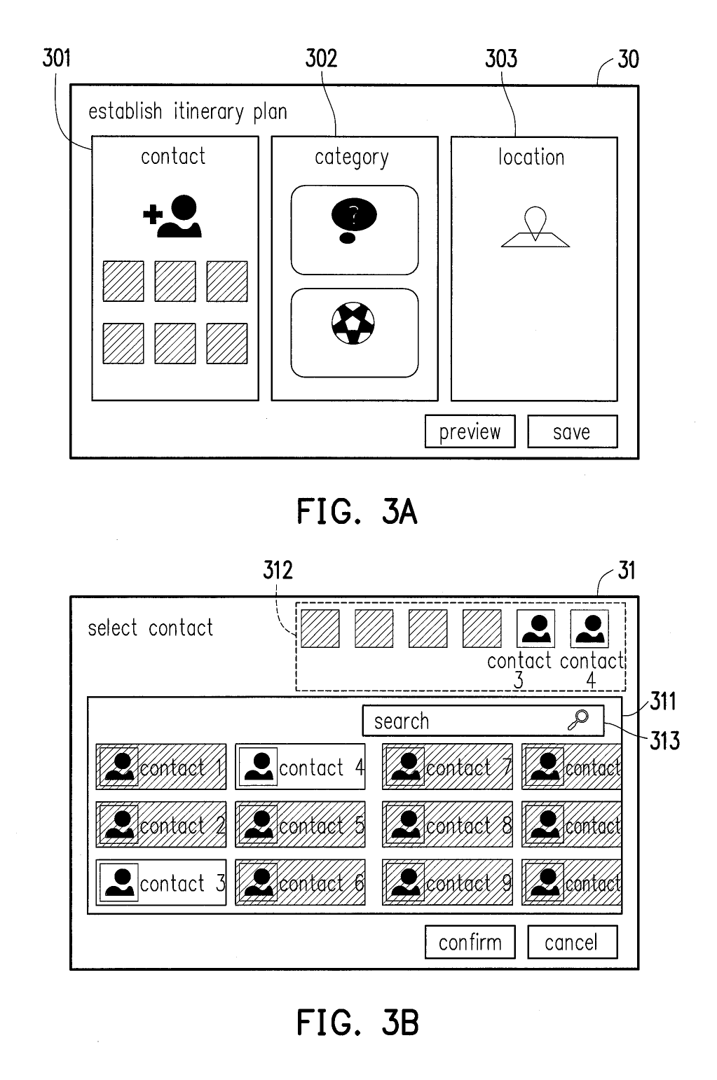

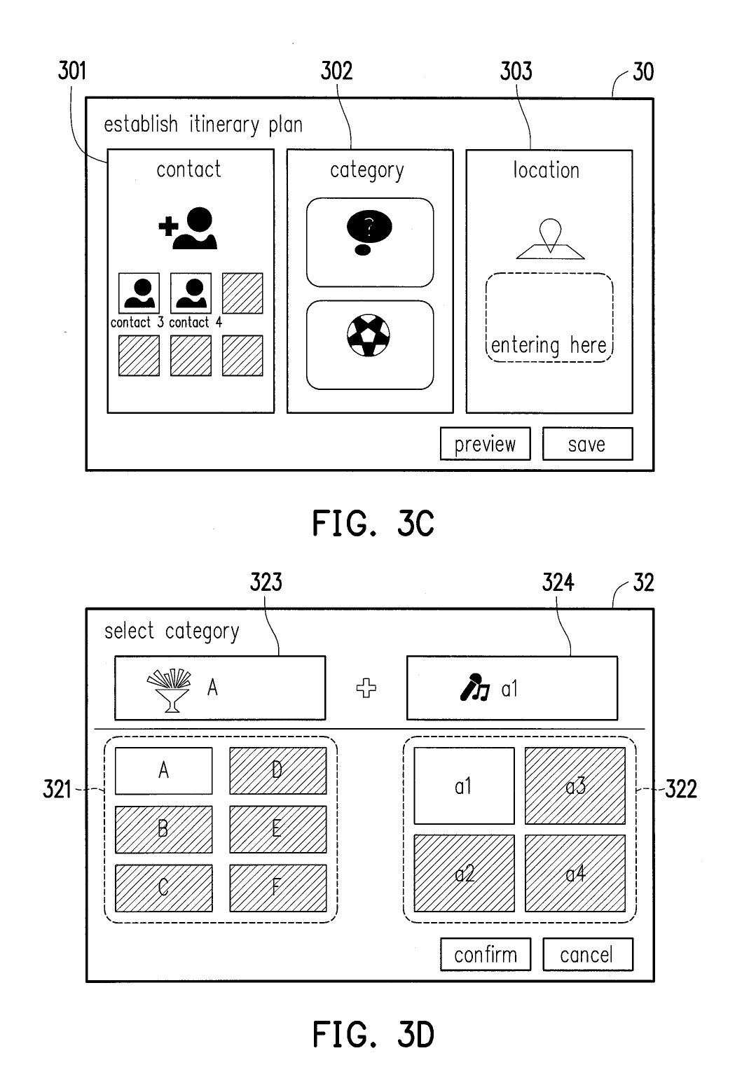

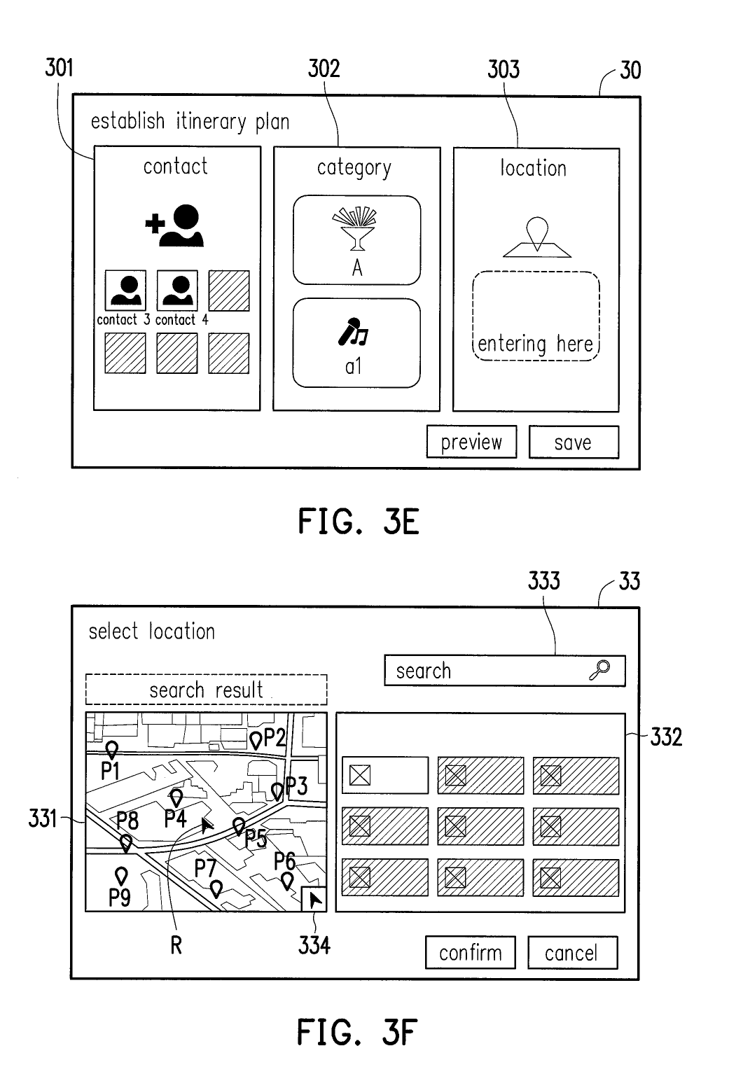

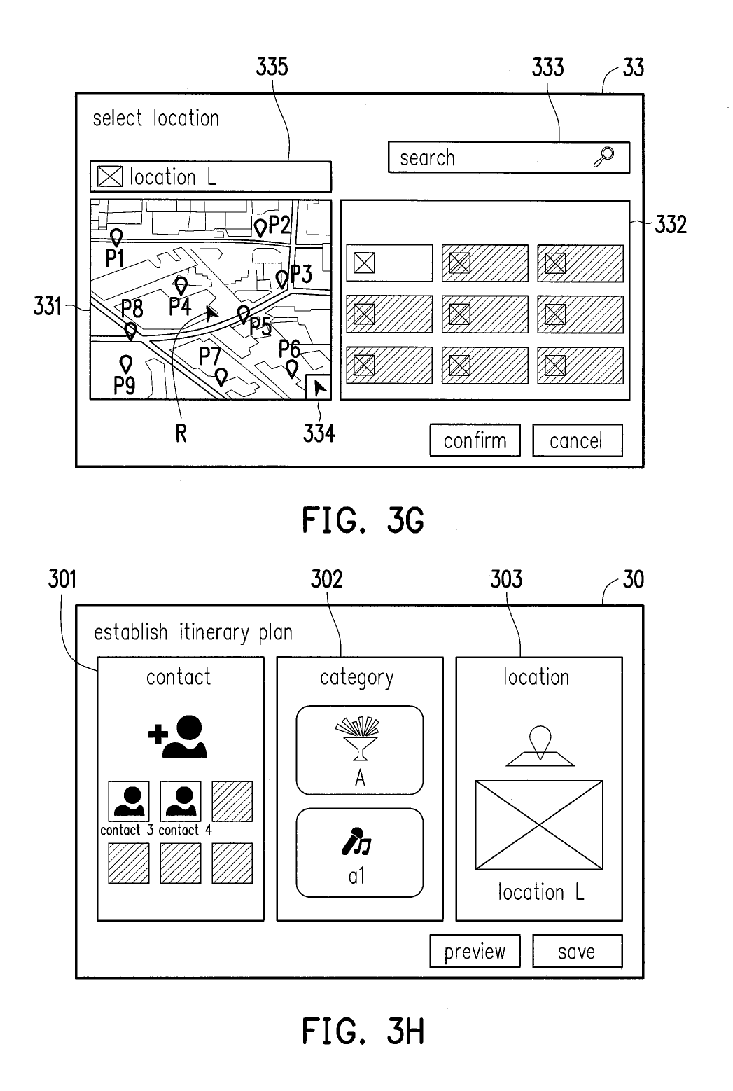

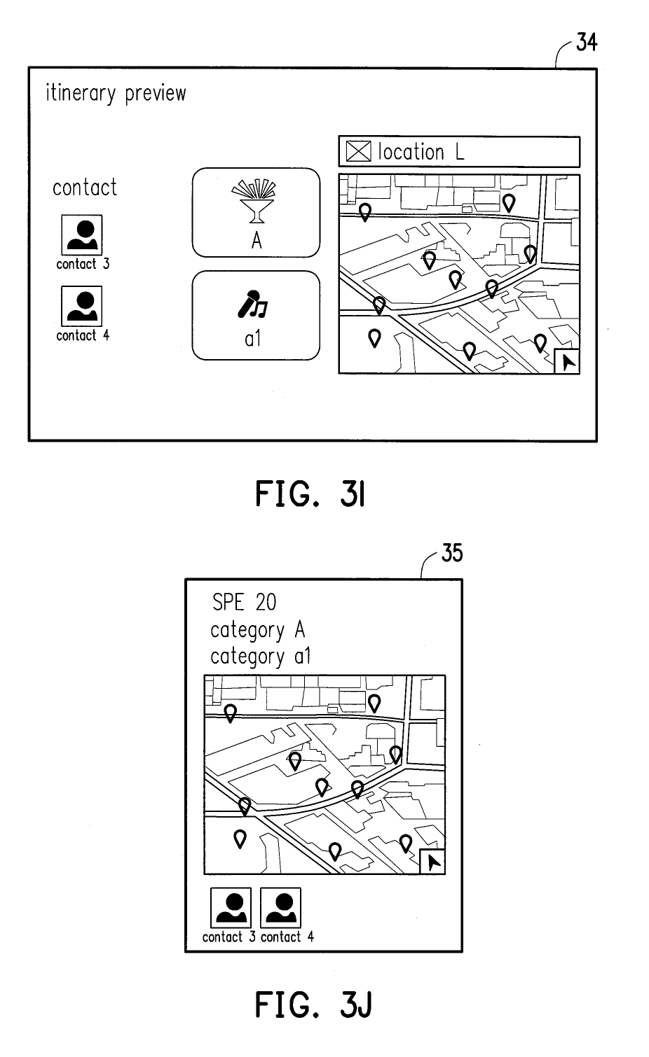

Further, the user is also capable of planning itinerary through aforesaid method for searching data. For instance, FIG. 3A to FIG. 3J are schematic diagrams illustrating flows for planning itinerary according to an embodiment of the invention. In the present embodiment, the computer program product further provides a user interface for the user to establish an itinerary plan. Detailed description is provided with reference to FIG. 1 and FIG. 3A to FIG. 3J.

When the user starts the computer program product, the display unit 120 may display a user interface 30 as shown in FIG. 3A. The user interface 30 includes a contact block 301, a category block 302 and a location block 303. The user may select the contact by clicking on the contact block 301, decide the POI category by clicking on the category block 302, and decide a target location by clicking on the location block 303. When the contact block 301 is selected, a selecting contact interface 31 as depicted in FIG. 3B is displayed, so as to receive a first operation command of the user through the selecting contact interface 31. When the category block 302 is selected, a selecting category interface 32 as depicted in FIG. 3D is displayed, so as to receive a second operation command of the user through the selecting category interface 32 to decide the POI category. When the location block 303 is selected, a selecting location interface 33 as depicted in FIG. 3F is displayed, so as to receive a third operation command of the user through the selecting location interface 33.

First, the user may click on the contact block 301 in the user interface 30 of FIG. 3A to enter the selecting contact interface 31 of FIG. 3B. In FIG. 3B, the selecting contact interface 31 includes a contact list 311, a selected list 312 and a search box 313. The contact list 311 includes a plurality of contacts (including contacts 1 to 9). Herein, an amount of the contacts being displayed is not particularly limited. The user may click on the contact list 311 for selection, and the selected contacts are simultaneously displayed on the selected list 312 on the top. Further, the user may also utilize the search box 311 to key in the keywords to quickly search for the contact.

After deciding contact information to be selected, a confirm button may be pressed to switch a frame into the user interface 30 as depicted in FIG. 3C. As shown in FIG. 3C, the selected contacts (i.e., “the contact 3” and “the contact 4”) are displayed in the contact block 301. Subsequently, the user may click on the category block 302 in the user interface 30 depicted in the FIG. 3C, so as to enter the selecting category interface 32 of FIG. 3D.

In FIG. 3D, the selecting category interface 32 includes a category list (herein, it includes a primary category list 321 and a secondary category list 322) and selected boxes 323 and 324. The secondary category list 322 displays the secondary categories included in the primary category being selected in the primary category list 321. Herein, when a primary category A is selected in the primary category list 321, the secondary category list 322 displays secondary categories a1 to a4 included in the primary category A, and the selected primary category A is simultaneously displayed in the selected box 323. Once the secondary category a1 is selected, the selected box 324 displays the selected secondary category a1. For example, the primary categories A to F are, “Nightlife”, “Shopping”,“Outdoor”, “Coffee”, “Dining”, “Others”, respectively. Nevertheless, said embodiment is merely an example, and the invention is not limited thereto. Assuming that the primary category “Nightlife” is clicked, a category name of the selected primary category “Nightlife” is simultaneously displayed in the selected box 323. Meanwhile, the secondary category list 322 may display the secondary categories thereof, such as “Karaoke”, “Entertainment”, “Night Club” and “Night Market”. When the secondary category “Karaoke” is selected, a category name of the secondary category “Karaoke” is displayed in the selected box 324.

After deciding the POI category (the secondary category a1 of the primary category A), the confirm button is pressed to switch the frame into the user interface 30 as depicted in FIG. 3E. As shown in FIG. 3E, the selected primary category A and the selected secondary category a1 are displayed in the category block 302. Thereafter, the user may click on the location block 303 in the user interface 30 depicted in the FIG. 3E, so as to enter the selecting location interface 33 of FIG. 3F. Herein, after deciding the POI category (the secondary category a1 of the primary category A), the processing unit 110 may search the specific data source (the POI list associated with the contact 3 and the contact 4), so as to display the POI data conformed to the POI category and fell within the preset search range in the selecting location interface 33.

In FIG. 3F, the selecting location interface 33 includes a map 331, a search result list 332 and a search box 333. The map 331 is configured to display the search result, namely, the POI data (represented by marked points P1 to P9) conformed to the POI category and fell within the preset search range with a reference location R as a center point. Herein, an initial displaying range of the map 331 is the preset search range set with the reference location R as the center. With an operation method similar to that of a general electronic map, the map 331 may move a displayed range thereof along any direction, return the display range back to the preset search range through a button 334, and zoom in or out the display range freely. In addition, detail information regrading each of the marked points P1 to P9 are also listed in the search result list 332. Further, the user may also key in the keywords in the search box 333 for searching the target location. As shown in FIG. 3G, for example, the marked point P1 is selected as the target location (a location L) from among the marked points P1 to P9, and displayed in a display box 335.

After the target location (the location L) is decided, the confirm button is pressed to switch the frame into the user interface 30 as depicted in FIG. 3H. As shown in FIG. 3H, the selected target location (the location L) is displayed in the location block 303. In FIG. 3H, when a preview button is pressed by the user, the frame is switched to a preview page 34 as depicted in FIG. 3I, and the selected contacts (the contact 3 and the contact 4), the selected POI category (the primary category A and the secondary category a1) and the selected target location (the location L) are displayed in the preview page 34. After a confirm button of FIG. 3I is pressed, the selected contact, the selected POI category and the selected target location are stored in an itinerary plan (e.g., an itinerary plan table 35 as depicted in FIG. 3J).

In summary, the POI data of one or more contacts may be selected as the specific data source in foregoing embodiments for searching desired data in the specific data source. Accordingly, the user is able to search the POI data of the contacts having similar interests, so as to improve accuracy in searching for the POI data of the user himself/herself. Further, by setting the filter condition, the places visited by both the user and the friends may be found, or places already visited by the user may be filtered out from the places visited by the friends. In addition, based on aforesaid method for searching data, the itinerary plan may be accomplished since the user is able to select the target location from the places already visited by the friends. Accordingly, the user may then ask the friends who has already visited the target location about details reading the itinerary plan.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for searching data, adapted for an electronic apparatus, comprising:
selecting at least one contact from a contact list so as to set a point of interest list associated with the selected contact as a specific data source, wherein the point of interest list comprises one or more point of interest data;
deciding a point of interest category;
obtaining a preset search range based on a reference location;
searching the specific data source for obtaining a search result conformed to the point of interest category and the preset search range; and
displaying the search result.

2. The method for searching data of claim 1, further comprising:
displaying a selecting contact interface, so as to list the contact list in the selecting contact interface; and
receiving an operation command of a user which selects the contact from the contact list through the selecting contact interface, so as to select the contact.

3. The method for searching data of claim 1, further comprising:
displaying a selecting category interface, so as to list a category list in the selecting category interface; and
receiving an operation command of a user which selects the point of interest category from the category list through the selecting category interface, so as to decide the point of interest category.

4. The method for searching data of claim 1, wherein the step of searching the specific data source for obtaining the search result conformed to the point of interest category and the preset search range comprises:
searching the specific data source for the one or more point of interest data conformed to the point of interest category; and
among the one or more point of interest data conformed to the point of interest category, setting the point of interest data that fell within the preset search range to the search result.

5. The method for searching data of claim 1, further comprising:
displaying a selecting location interface for displaying the search result;
receiving an operation command of a user which selects one of the point of interest data from the search result through the selecting location interface, so as to set the selected point of interest data as a target location; and
storing the selected contact, the selected point of interest category and the selected target location.

6. The method for searching data of claim 1, wherein before the step of obtaining the preset search range based on the reference location, the method further comprises:
detecting a current location of the electronic apparatus, and using the current location as the reference location.

7. The method for searching data of claim 1, further comprising:
receiving a filter condition, so as to obtain the point of interest data conformed to the filter condition from the search result, wherein the filter condition comprises the point of interest data associated with a user of the electronic apparatus.

8. A method for planning itinerary, adapted for an electronic apparatus, comprising:
selecting at least one contact from a contact list so as to set a point of interest list associated with the selected contact as a specific data source, wherein the point of interest list comprises one or more point of interest data;
deciding a point of interest category;
obtaining a preset search range based on a reference location;
searching the specific data source for displaying the point of interest data conformed to the point of interest category and fell within the preset search range;
selecting one of the displayed point of interest data as a target location; and
storing the selected contact, the selected point of interest category and the selected target location.

9. The method for planning itinerary of claim 8, further comprising:
providing a user interface for a user to establish an itinerary plan, wherein the user interface comprises a contact block, a category block and a location block, the contact block being used to select the contact, the category block being used to decide the point of interest category, and the location block being used to decide the target location.

10. The method for planning itinerary of claim 9, wherein:
when the contact block is selected, displaying a selecting contact interface to list the contact list, and receiving a first operation command of the user through the selecting contact interface, so as to select the contact from the contact list;
when the category block is selected, displaying a selecting category interface to list a category list, and receiving a second operation command of the user through the selecting category interface, so as to decide the point of interest category; and
when the location block is selected, displaying a selecting location interface to display the point of interest data conformed to the point of interest category and fell within the preset search range, and receiving a third operation command of the user through the selecting location interface, so as to select one of the displayed point of interest data as the target location.
